(19) United States
(12) Patent Application Publication
(10) Pub. No.: US 2013/0055139 A1
(43) Pub. Date: Feb. 28, 2013

(54) TOUCH INTERFACE FOR DOCUMENTATION OF PATIENT ENCOUNTER

(71) Applicants: David A. Polivka, Bluemont, VA (US); Daniel A. Ganier, Shenandoah Junction, WV (US)

(72) Inventors: David A. Polivka, Bluemont, VA (US); Daniel A. Ganier, Shenandoah Junction, WV (US)

(21) Appl. No.: 13/401,571

(22) Filed: Feb. 21, 2012

Related U.S. Application Data
(60) Provisional application No. 61/444,875, filed on Feb. 21, 2011.

(51) Int. Cl. G06F 3/048

(52) U.S. Cl. 715/776

(57) ABSTRACT

A mobile computing device includes a touch sensitive display. A note-style interface is displayed on the touch sensitive display. Findings are documented in the note-style display by receiving handwritten inputs from the caregiver through the touch sensitive display.

### CROSS-REFERENCE TO RELATED APPLICATION

This application claims priority to U.S. Ser. No. 61/444,875, filed on Feb. 21, 2011, entitled TOUCH INTERFACE FOR DOCUMENTATION OF PATIENT ENCOUNTER, the disclosure of which is hereby incorporated by reference in its entirety.

### TECHNICAL FIELD

The present disclosure relates to electronic medical records, and more particularly to a caregiver interface for electronic medical records that receives handwritten inputs from the caregiver.

### BACKGROUND

When a caregiver interacts with a patient, the caregiver often makes a record of the findings from that interaction in a patient note. For example, the caregiver might record in the patient note one or more symptoms that the patient was experiencing, the results of a physical examination that the caregiver performed, an assessment of the patient's condition, a plan for treatment of the symptoms, as well as other possible information. After the patient note is completed, the patient note is stored in the patient's medical record, where it can be reviewed by the caregiver during subsequent interactions.

### SUMMARY

In general terms, this disclosure is directed to a caregiver interface for electronic medical records that receives handwritten inputs from the caregiver. In one possible configuration and by non-limiting example, the caregiver interface displays a patient note. Findings are documented in the patient note through a touch sensitive interface.

One aspect is a method of documenting a patient encounter, the method comprising: generating a note-style user interface containing a patient note with a computing device, the patient note including at least one note item describing an aspect of a patient encounter; identifying a gesture input received through a touch-sensitive display, the gesture input identifying the note item; and executing a command associated with the gesture input to perform an operation involving the note item.

Another aspect is a method of documenting a patient encounter, the method comprising: generating a note-style user interface containing a patient note with a computing device, the patient note including at least one note item describing an aspect of a patient encounter; identifying an input received through a touch-sensitive display, the input including at least one stroke and identifying the note item; and executing a command associated with the input to perform an operation involving the note item.

Yet another aspect is an electronic medical records system comprising: a server computing device including at least one processing device; and at least one computer readable storage device in data communication with the server device, the at least one computer readable storage device storing data instructions, which when executed by the server computing device, cause the server computing device to generate: a user interface engine that generates web page data defining a note-style interface including a patient note, the patient note including at least one note item, the note item defining a finding of a patient encounter; and at least a part of a handwriting recognition engine that identifies a gesture input received through a touch-sensitive display of a mobile computing device, where the gesture input identifies the note item, and the handwriting recognition engine further executes a command associated with the gesture input to perform an operation involving the note item.

### BRIEF DESCRIPTION OF THE DRAWINGS

FIG. 1 is a schematic diagram illustrating an exemplary electronic medical records system.

FIG. 2 is a schematic block diagram illustrating an exemplary architecture of a computing device for implementing aspects of the electronic medical records system shown in FIG. 1.

FIG. 3 is a schematic block diagram illustrating an exemplary architecture of an application program.

FIG. 4 is a flow chart illustrating an exemplary method of operating a data center interface engine.

FIG. 5 is a schematic block diagram illustrating an exemplary format of downloaded historical records.

FIG. 6 is a schematic diagram illustrating another example of an electronic medical records system.

FIG. 7 is a schematic block diagram illustrating exemplary components of the electronic medical records system.

FIG. 8 is a flow chart illustrating an example of a touch input evaluation engine.

FIG. 9 is a screen shot of an example user interface generated by a user interface engine.

FIG. 10 is a screen shot of an example user interface illustrating a gesture input provided to document a patient encounter.

FIG. 11 is another screen shot of the user interface after receipt of the gesture input shown in FIG. 10, and illustrating an additional gesture input.

FIG. 12 is another screen shot of the user interface after receipt of the gesture input shown in FIG. 11, and further illustrating an additional gesture input.

FIG. 13 is another screen shot of the user interface after receipt of the gesture input shown in FIG. 12, and further illustrating the receipt of a handwriting input.

FIG. 14 is another screen shot of the user interface after receipt of the handwriting input shown in FIG. 13.

FIG. 15 is a table illustrating exemplary gesture inputs and associated commands.

FIG. 16 is another screen shot of the user interface illustrating the receipt of a move input.

FIG. 17 is another screen shot of the user interface after receipt of the move input shown in FIG. 16.

FIG. 18 is another screen shot of the user interface illustrating the receipt of another move input.

FIG. 19 is another screen shot of the user interface after receipt of the move input shown in FIG. 18.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

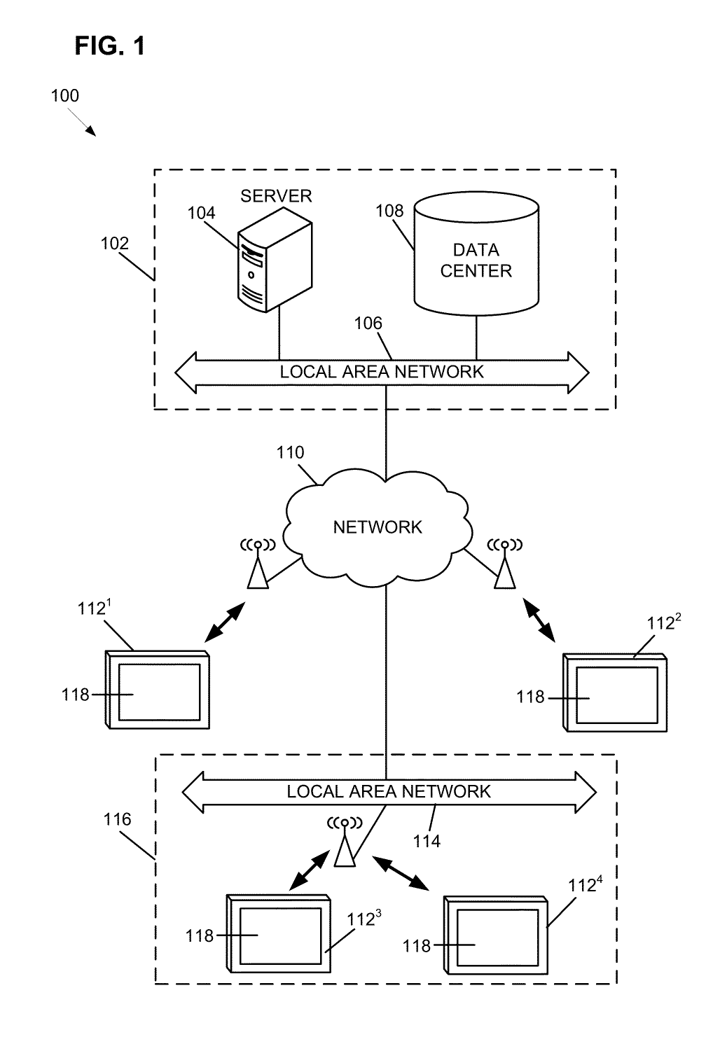

FIG. 1 illustrates an exemplary embodiment of an electronic medical records system 100. The system 100 includes a healthcare information management system 102, a network 110, and client computing devices 112. Client computing devices 112 include stand-alone computing devices 112¹ and 112² as well as networked computing devices 112³ and 112⁴ that are connected to local area network 114.

Some embodiments of healthcare information management system 102 include a server 104 and a data center 108 that communicate across local area network 106. The healthcare information management system 102 operates to store medical records of patients and to send selected portions of the medical records across network 110 when requested by a computing device 112. The healthcare information management system 102 can be located at the same location (such as in the same room, building, or facility) as one or more of the computing devices 112. Alternatively, the healthcare information management system 102 is located remote from the computing devices 112, such as in a different building, city, state, country, or continent.

The server 104 controls access to records stored in the healthcare information management system 102, in some embodiments. In one example embodiment, the server 104 is a computing device that includes a database software application, such as the SQL SERVER® database software distributed by MICROSOFT® Corporation. In some other possible embodiments, the server 104 is a Web server or a file server. When a request for a record is received by the server 104, the server retrieves the record from the data center 108 and sends it across the network 110 to the computing device 112 that requested it. Some alternative embodiments do not include a server 104, and, instead, computing devices 112 are configured to retrieve information directly from the data center 108.

The data center 108 is a data storage device configured to store patient medical records. Examples of a possible data center 108 include a hard disk drive, a collection of hard disk drives, digital memory (such as random access memory), a redundant array of independent disks (RAID), or other data storage devices. In some embodiments records are distributed across multiple local or remote data storage devices. The data center 108 stores data in an organized manner, such as in a hierarchical or relational database structure. Although the data center 108 is illustrated as being separated from the computing devices 112 by the network 110, the data center 108 is alternatively a local data storage device of a computing device 112 or is connected to the same local area network 114 as the computing device 112.

The network 110 communicates digital data between one or more computing devices, such as between the healthcare information management system 102 and the computing devices 112. Examples of the network 110 include a local area network and a wide area network, such as the Internet.

In some embodiments, the network 110 includes a wireless communication system, a wired communication system, or a combination of wireless and wired communication systems. A wired communication system can transmit data using electrical or optical signals in various possible embodiments. Wireless communication systems typically transmit signals via electromagnetic waves, such as in the form of radio frequency (RF) signals. A wireless communication system typically includes a RF transmitter for transmitting radio frequency signals, and an RF receiver for receiving radio frequency signals. Examples of wireless communication systems include Wi-Fi communication devices (such as utilizing wireless routers or wireless access points), cellular communication devices (such as utilizing one or more cellular base stations), and other wireless communication devices.

In some example embodiments, computing devices 112 are computing devices used by a caregiver that display a caregiver interface 118. Caregivers include physicians, psychiatrists, counselors, therapists, medical assistants, secretaries, receptionists, or other people that are involved in providing care to a patient. Other embodiments present the user interface to users that are not caregivers. In some embodiments, a computing device 112 is located at a point of care, such as within a room where a caregiver and a patient interact. In other embodiments, a computing device 112 is located near the point of care, such as in a hallway or nearby room. However, in other possible embodiments the computing device 112 is not located near the point of care.

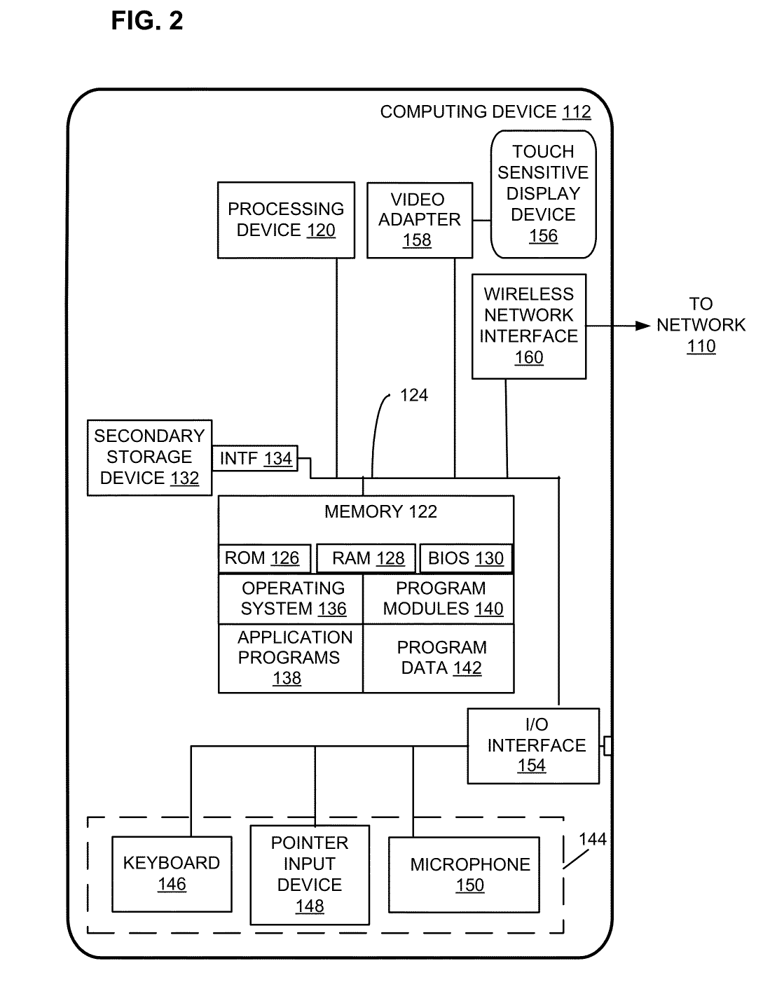

In some embodiments, computing devices are mobile computing devices, such as a tablet computer (such as the iPad® device available from Apple, Inc.), a smartphone, or other mobile computing devices. In some embodiments, computing devices 112 include a touch sensitive display 156, such as shown in FIG. 2, for receiving input from a user.

In one example embodiment, the electronic medical records system 100 includes stand-alone computing devices 112¹ and 112², as well as networked computing devices 112³ and 112⁴. Stand-alone computing devices 112¹ and 112² connect directly to network 110 and are not part of an additional local area network. In some embodiments, the stand-alone computing devices connect through a wireless network, such as a cellular telephone network. Networked computing devices 112³ and 112⁴ are connected to a local area network 114 which may be within a facility 116, such as a hospital, clinic, office, or other building. In some embodiments, a connection to the local area network is made wirelessly through a wireless access point connected to the local area network. More or fewer computing devices 112 are included in other possible embodiments and can be located in one or more facilities or locations.

FIG. 2 illustrates an exemplary architecture of a computing device that can be used to implement aspects of the present disclosure, including the server 104 or the computing device 112, and will be referred to herein as the computing device 112. The computing device 112 is used to execute the operating system, application programs, and software modules (including the software engines) described herein.

The computing device 112 includes, in some embodiments, at least one processing device 120, such as a central processing unit (CPU). A variety of processing devices are available from a variety of manufacturers, for example, Intel or Advanced Micro Devices. In this example, the computing device 112 also includes a system memory 122, and a system bus 124 that couples various system components including the system memory 122 to the processing device 120. The system bus 124 is one of any number of types of bus structures including a memory bus, or memory controller; a peripheral bus; and a local bus using any of a variety of bus architectures.

Examples of computing devices suitable for the computing device 112 include a desktop computer, a laptop computer, a tablet computer, a mobile phone device such as a smart phone, or other devices configured to process digital instructions.

The system memory 122 includes read only memory 126 and random access memory 128. A basic input/output system 130 containing the basic routines that act to transfer information within computing device 112, such as during start up, is typically stored in the read only memory 126.

The computing device 112 also includes a secondary storage device 132 in some embodiments, such as a hard disk drive, for storing digital data. The secondary storage device 132 is connected to the system bus 124 by a secondary storage interface 134. The secondary storage devices and their associated computer readable media provide nonvolatile storage of computer readable instructions (including application programs and program modules), data structures, and other data for the computing device 112.

Although the exemplary environment described herein employs a hard disk drive as a secondary storage device, other types of computer readable storage media are used in other embodiments. Examples of these other types of computer readable storage media include magnetic cassettes, flash memory cards, digital video disks, Bernoulli cartridges, compact disc read only memories, digital versatile disk read only memories, random access memories, or read only memories. Some embodiments include non-transitory media.

A number of program modules can be stored in secondary storage device 132 or memory 122, including an operating system 136, one or more application programs 138, other program modules 140, and program data 142.

In some embodiments, computing device 112 includes input devices to enable the caregiver to provide inputs to the computing device 112. Examples of input devices 144 include a keyboard 146, pointer input device 148, microphone 150, and touch sensitive display 156. Other embodiments include other input devices 144. The input devices are often connected to the processing device 120 through an input/output interface 154 that is coupled to the system bus 124. These input devices 144 can be connected by any number of input/output interfaces, such as a parallel port, serial port, game port, or a universal serial bus. Wireless communication between input devices and interface 154 is possible as well, and includes infrared, BLUETOOTH® wireless technology, 802.11a/b/g/n, cellular, or other radio frequency communication systems in some possible embodiments.

In this example embodiment, a touch sensitive display device 156 is also connected to the system bus 124 via an interface, such as a video adapter 158. The touch sensitive display device 156 includes touch sensors for receiving input from a user when the user touches the display. Such sensors can be capacitive sensors, pressure sensors, or other touch sensors. The sensors not only detect contact with the display, but also the location of the contact and movement of the contact over time. For example, a user can move a finger or stylus across the screen to provide written inputs. The written inputs are evaluated and, in some embodiments, converted into text inputs.

In addition to the display device 156, the computing device 112 can include various other peripheral devices (not shown), such as speakers or a printer.

When used in a local area networking environment or a wide area networking environment (such as the Internet), the computing device 112 is typically connected to the network through a network interface, such as a wireless network interface 160. Other possible embodiments use other communication devices. For example, some embodiments of the computing device 112 include an Ethernet network interface, or a modem for communicating across the network.

The computing device 112 typically includes at least some form of computer-readable media. Computer readable media includes any available media that can be accessed by the computing device 112. By way of example, computer-readable media include computer readable storage media and computer readable communication media.

Computer readable storage media includes volatile and nonvolatile, removable and non-removable media implemented in any device configured to store information such as computer readable instructions, data structures, program modules or other data. Computer readable storage media includes, but is not limited to, random access memory, read only memory, electrically erasable programmable read only memory, flash memory or other memory technology, compact disc read only memory, digital versatile disks or other optical storage, magnetic cassettes, magnetic tape, magnetic disk storage or other magnetic storage devices, or any other medium that can be used to store the desired information and that can be accessed by the computing device 112.

Computer readable communication media typically embodies computer readable instructions, data structures, program modules or other data in a modulated data signal such as a carrier wave or other transport mechanism and includes any information delivery media. The term “modulated data signal” refers to a signal that has one or more of its characteristics set or changed in such a manner as to encode information in the signal. By way of example, computer readable communication media includes wired media such as a wired network or direct-wired connection, and wireless media such as acoustic, radio frequency, infrared, and other wireless media. Combinations of any of the above are also included within the scope of computer readable media.

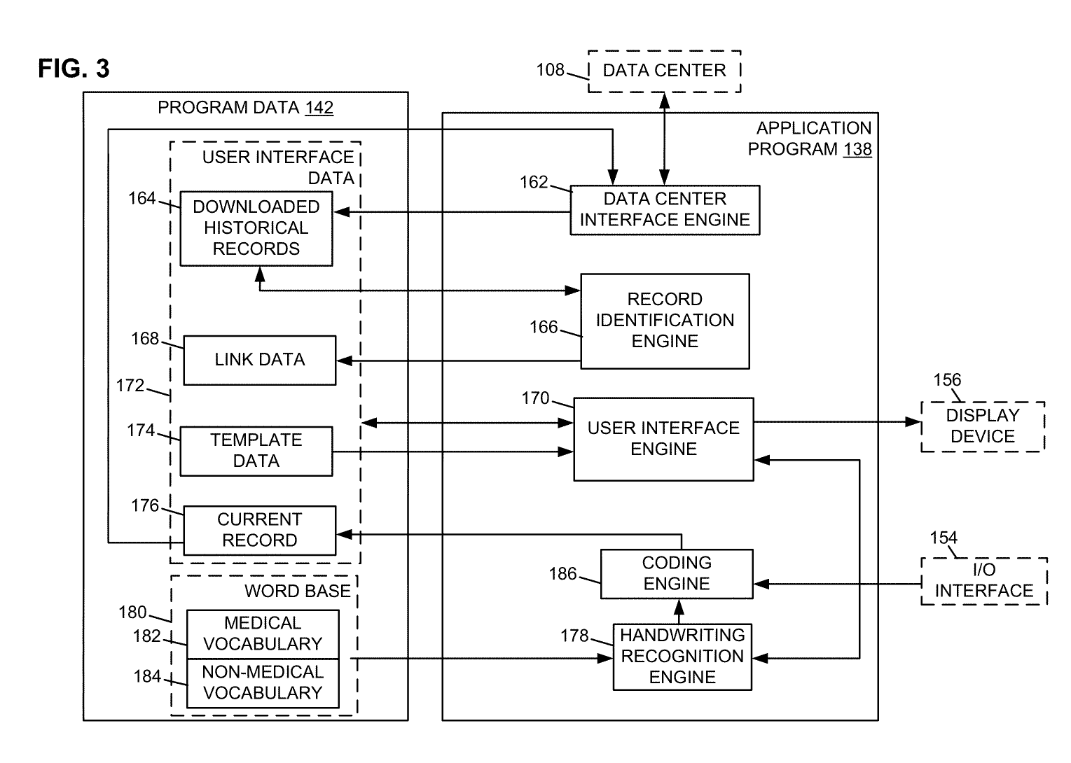

FIG. 3 illustrates an exemplary architecture of the application program 138 and the program data 142 of the computing device 112 (shown in FIG. 2).

The application program 138 includes a plurality of engines that, when executed by the processor, perform one or more operations of the application program 138. The engines include a data center interface engine 162, a record identification engine 166, a user interface engine 170, a handwriting recognition engine 178, and a coding engine 186.

Program data 142 is stored in a data storage device, such as the memory 122 or the secondary storage device 132 (shown in FIG. 2) of the computing device 112 or another server computing device.

In some embodiments, program data 142 includes user interface data 172 and a word base 180. The user interface data 172 includes data used to generate user interfaces or that is displayed in user interfaces. Examples of user interface data 172 includes downloaded historical records 164, link data 168, template data 174, and current record 176. The word base 180 includes, for example, medical vocabulary 182 and non-medical vocabulary 184.

In an exemplary embodiment, the data stored in program data 142 can be represented in one or more files having any format usable by a computer. Examples include text files formatted according to a markup language and having data items and tags to instruct computer programs and processes how to use and present the data item. Examples of such formats include HTML, XML, and XHTML, although other formats for text files can be used. Additionally, the data can be represented using formats other than those conforming to a markup language.

In some embodiments, findings, such as symptoms and other history, physical exam findings, tests, diagnoses and therapy, are stored as data items in one or more data records. In some embodiments, data records are a set of one or more data items, such as in a format that can be read by a computing device. An example embodiment is a database record. Other examples of data records include tables, text files, computer executable files, data structures, or other structures for associating data items.

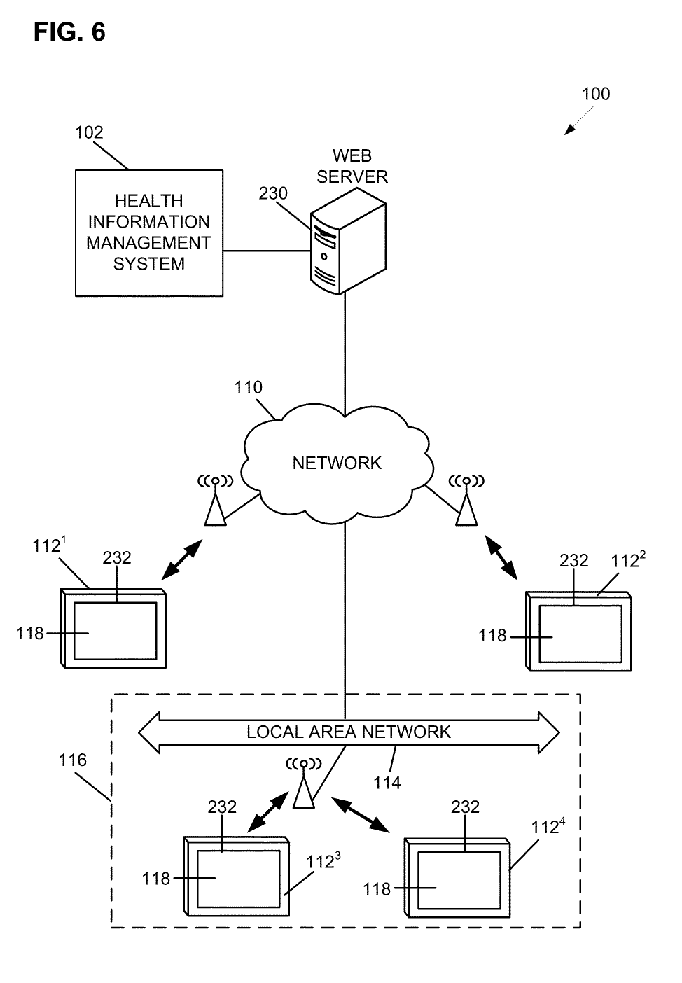

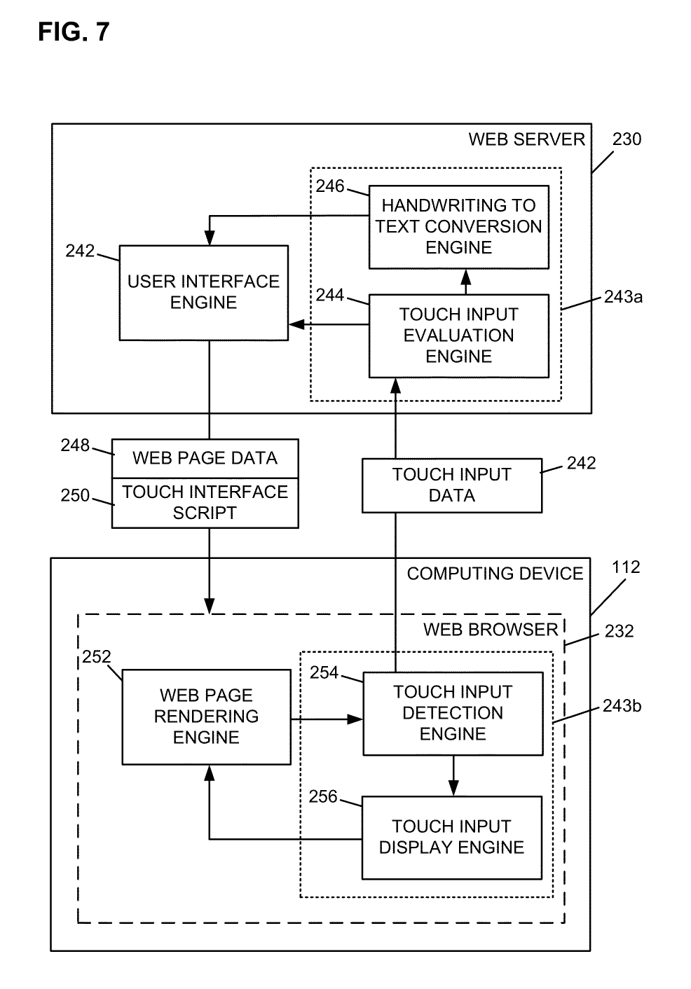

In some embodiments, application program 138 communicates with the data center 108 of the healthcare information management system 102, and also communicates with the display device 156 and the input/output interface 154 of the computing device 112. Such communication between the application program 138 and healthcare information management system 102 can occur through the server 104. In some possible embodiments the application program 138 resides on computing device 112, while in other possible embodiments the application program 138 resides on a server. As one example, if the application program 138 resides on the server, the caregiver interface 118 can be presented as a web page file that is communicated to the computing device 112. In this example, the computing device 112 receives the web page data from the server and generates the caregiver interface 118 using a Web browser software application. In some embodiments, the application program 138 includes a combination of software running on the server and software running on the computing device 112. For example, web page data from the server can include instructions, such as in the form of a script language, which can be executed by the computing device 112. An example of a suitable script language is JavaScript. An example is illustrated and described in more detail herein with reference to FIGS. 6-7.

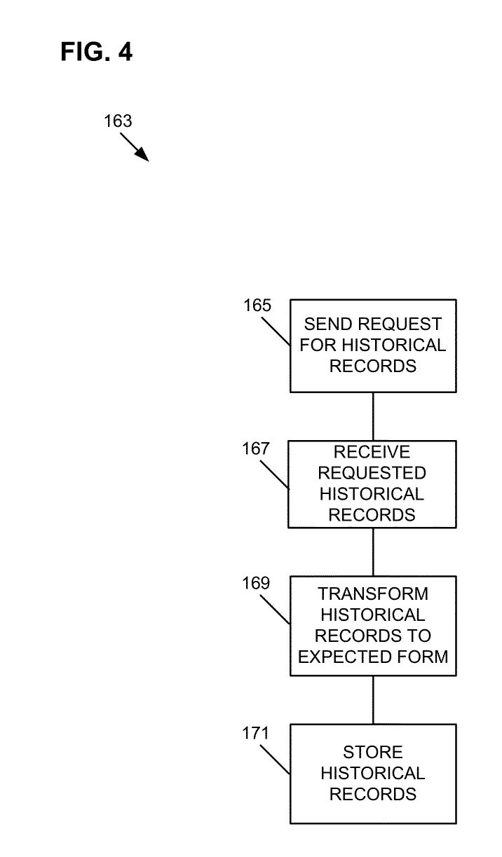

The data center interface engine 162 operates to download historical records from the data center 108. An exemplary method of operating a data center interface engine 162 is illustrated and described in more detail with reference to FIG. 4, discussed below.

Some embodiments of the application program 138 are configured to accept one of a variety of data center interface engines 162 as plug-in modules. The plug-in modules allow the application program 138 to be compatible with various data center 108 formats without requiring custom programming of the application program 138 for every possible format of records in the data center 108.

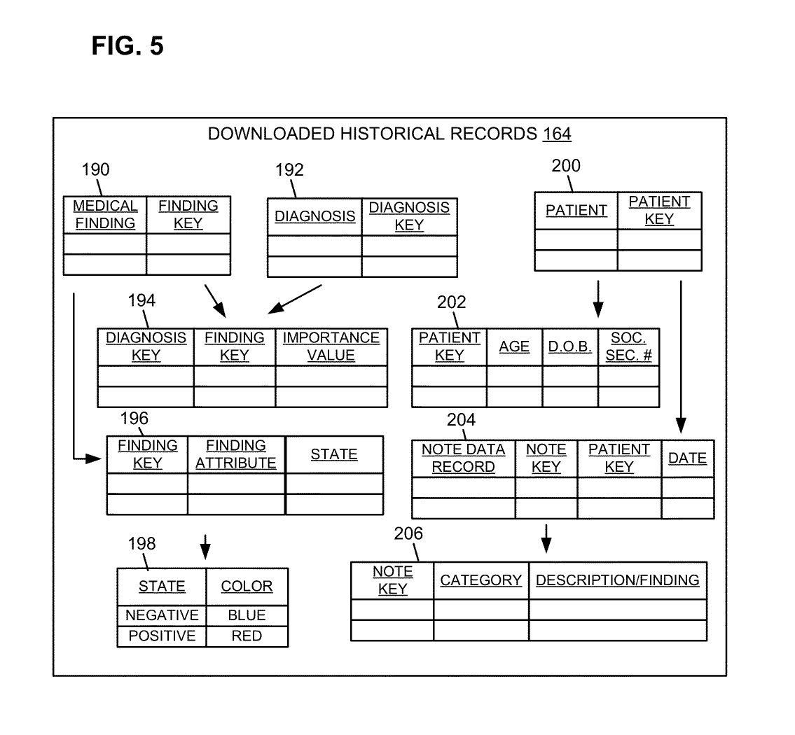

In some embodiments, the data center interface engine 162 is a plug-in module installed on the computing device 112, which is selected from a plurality of plug-in modules according to the type of data center 108 with which the engine 162 is intended to communicate. The selected plug-in module is configured to communicate with and receive historical records in a format that matches the format of records in the data center 108, and to transform the historical records into the second different format expected by the application program 138. FIG. 5 illustrates an example format of downloaded historical records 164, as described in more detail below.

Some example embodiments of the application program 138 include a record identification engine 166. The record identification engine 166 operates to identify the relationships between historical records. More specifically, the record identification engine 166 identifies historical records that contain a common data item, and then stores the relationships between the historical records and the data item as link data 168 in the program data 142.

In some embodiments, the record identification engine 166 includes at least two modes of operation. The first mode is a template initiation mode that begins when a template is selected by the caregiver. The second mode is an update mode that updates the links between records as new information is obtained from a caregiver as discussed in more detail below.

Some embodiments of the application program 138 include the user interface engine 170 that generates the caregiver interface 118 on the display device 156.

The user interface engine 170 utilizes the user interface data 172 of the program data 142 to generate the caregiver interface. In this example, the user interface data 172 includes the downloaded historical records 164, the link data 168, the template data 174, and the current record 176 that are stored in the program data 142. The template data 174 stores a variety of different templates that can be used by the user interface engine 170 to generate a current note data display, as discussed in more detail herein. The templates are used by the user interface engine 170, for example, to organize findings entered by a caregiver and to suggest additional findings that may be relevant to the patient's condition.

The user interface engine 170 receives inputs from a caregiver through the input/output interface 154. Examples of such inputs include inputs from a keyboard 146, a pointer input device 148, a microphone 150, or touch sensitive display device 156. In some embodiments, touch inputs are received from a caregiver through the touch sensitive display device 156. The touch inputs are processed by a handwriting recognition engine 178, discussed in more detail below, and then provided as an input to the user interface engine 170 and the coding engine 186.

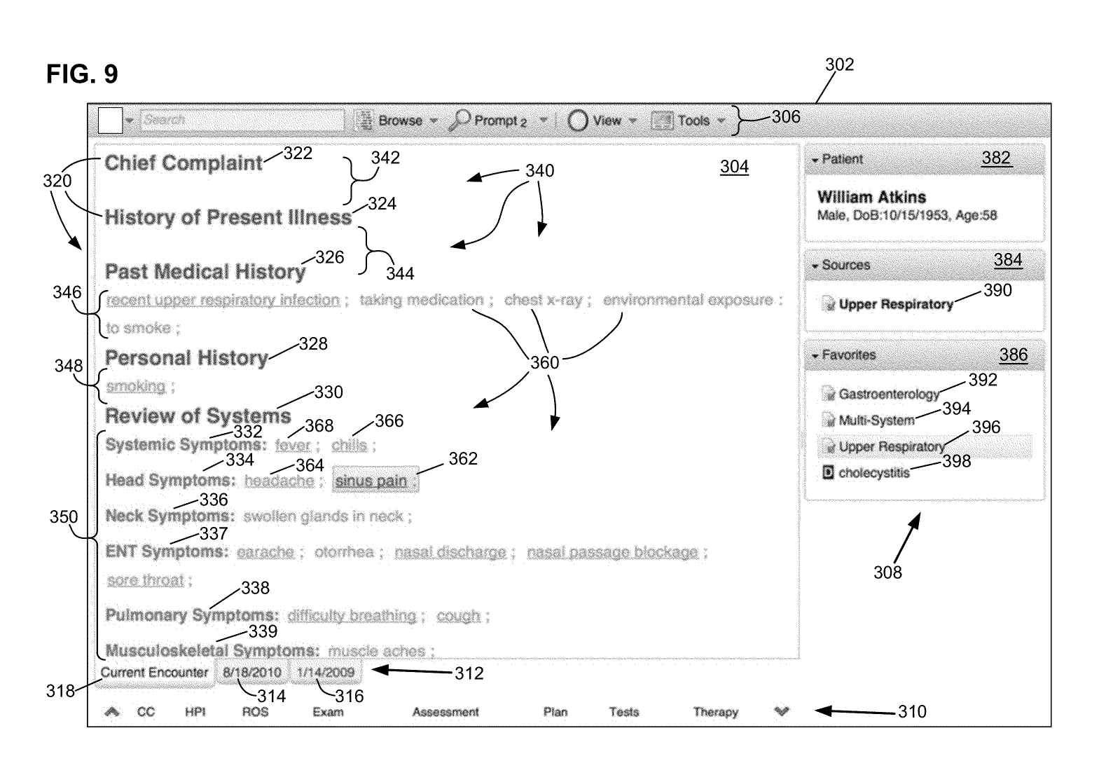

Examples of user interface displays generated by the user interface engine 170 are illustrated in FIGS. 9-14 and 16-19.

Some embodiments include the handwriting recognition engine 178. Upon receipt of a touch input from a user, as detected by the touch sensitive display 156, shown in FIG. 2, a determination is made whether the input is a selection or a handwriting input. A selection input is, for example, the selection of a particular point on the screen, such as to identify a particular selectable control (e.g., a button or icon). A selection input typically requires an identification of the coordinates of the input, and no further processing of the input is required. However, if the input is determined to be a handwriting input, the input is passed to the handwriting recognition engine for further processing.

The handwriting recognition engine 178 operates to convert a handwritten input, consisting of characters, such as letters, numbers, or symbols, into a text version consisting of those characters that can be more easily processed by the computing device. In some embodiments, the handwriting recognition engine 178 evaluates an input to determine whether the input is a data input or a command input. For example, in some embodiments certain gestures can be received, which are identified as a command input by the handwriting recognition module. Upon identification of a command input, an associated operation is performed.

For example, in some embodiments a user interface generated by the user interface module is provided to receive input from a user. The user can provide the input by writing the input on the screen, at any location on the screen, and in whatever size writing the user likes, so long as the writing fits within the bounds of the screen, or a predetermined window of the user interface. Upon completion of the written input, the user touches the screen with a finger or stylus, and moves the finger or stylus in the shape a predefined gesture. An example of a gesture is a downward vertical movement, followed by a movement to the left, creating a horizontally flipped L-shape. The input is identified by the handwriting module as a handwritten input followed by a command input defined by the gesture. Upon detection of the gesture, the handwritten input is evaluated by the handwriting recognition engine 178, which converts the input into a text input. The text is then passed to the user interface engine 170, which displays the text at a particular location in the user interface. For example, when the user completes the gesture, the last point of the gesture defines the location where the input should be inserted.

In some embodiments, the handwriting recognition engine 178 includes a touch input detection engine, a touch input display engine, a touch input evaluation engine, and a handwriting to text conversion engine. Examples of these engines are described in more detail herein, with reference to FIG. 7 and handwriting recognition engine 243, which includes engines 254, 256, 246, and 244, except that the engines in FIG. 7 are distributed across two or more computing devices, where in the example shown in FIG. 3, the handwriting recognition engine 178 operates on a single computing device.

FIG. 4 is a flow chart illustrating an example of the data center interface engine 162, and also illustrating a method 163 of converting historical records from a first format into a second different format.

In some embodiments, the method 163 includes operations 165, 167, 169, and 171 that are performed by a processor (such as the processing device 120, shown in FIG. 2), or a processor of a server computing device.

In this example, the method 163 begins with an operation 165, in which the data center interface engine 162 of the computing device 112 sends a request for historical records to the healthcare information management system 102. The request identifies the records that are needed from the data center 108. The identification of the records can be either an identification of specific records, or an identification of a search query to be performed across the records stored in the data center 108. In some embodiments, the operation 165 involves sending a request to the server 104, which receives the request, locates the records identified in the request, and sends the records back to the data center interface engine 162. The operation 167 is then performed to receive the records.

After the records are downloaded, the operation 169 is then performed to transform the historical records from a first format (the format the records are in when retrieved from the data center 108) into a second format (the format that the application program 138 needs the historical records to be in). A wide variety of formats can be used to store patient medical records in the data center 108. For example, in one possible embodiment, the first format of the historical records is an SQL database format. In another possible embodiment, the first format is an extensible markup language format. Other relational database formats are used in other embodiments. Yet other embodiments use other data structures to store historical records in the data center 108.

The application program 138 is configured to use the historical data in a second format, which can be different from the first format. An example of the second format is an extensible markup language format utilizing linked lists, and/or hash tables to organize and relate the data. As a result, the operation 169 transforms the historical records from the first format into the second format.

Once the historical records have been transformed to the desired format, they are stored during the operation 171 as downloaded historical records in the program data 142 (such as shown in FIG. 3). In some embodiments, however, the historical records received in the operation 167 are usable by the application program 138 in their received form. In this case, the operation 169 does not need to be performed, and the operation 171 is instead performed following the operation 167 to store the downloaded historical records in the program data 142.

FIG. 5 illustrates an example of downloaded historical records 164 stored in one or more computer readable storage devices. In this example, downloaded historical records 164 are contained in a plurality of data structures in the form of tables utilizing data keys. Other embodiments include other types of data structures and other methods of linking data structures. The format shown in FIG. 5 is also an example format of a current record 176, shown in FIG. 3.

In one example embodiment, the downloaded historical records 164 include a medical findings table 190, a diagnosis table 192, a findings importance table 194, a state table 196, a color table 198, a patient table 200, a patient data table 202, a note data record table 204, and a note details table 206. Additional tables are included in other embodiments as needed. Further, some embodiments include different table structures, such as to merge data from multiple tables into a single table or to separate data from a single table into multiple tables.

The medical findings table 190 includes a list of the available medical findings, and maps each medical finding to a unique finding key. Medical findings identify physical characteristics of a person, such as the patient. In some embodiments, medical findings include symptoms (also referred to herein as chief complaints) that a patient is experiencing, relevant medical history of the patient or patient's family, findings from a physical examination of the patient, diagnoses of the patient, tests performed on a patient and the results of the tests, and therapy performed or prescribed. Each finding is mapped to a unique finding key, which can be used to refer to the medical finding in other data structures. Some embodiments, for example, include a medical findings table 190 having more than 280,000 possible medical findings.

In some embodiments, the medical findings are organized in a hierarchical structure that provides various levels of abstraction for medical findings. As one example, a hierarchical structure can include multiple levels, where findings in the first level are generic descriptions of medical findings, and findings in the lower levels include more detailed descriptions of those medical findings. For example, a first level medical finding might be a cough, while a second level medical finding associated with the cough might be a brassy cough. Additional data structures are provided in some embodiments to link medical findings to the various levels in a hierarchical structure. Some embodiments further associate each finding with a category, such as by including a category column (not shown) in the medical finding table 190. Examples of findings categories include a symptom, a medical history, a physical examination finding, a diagnosis, a test, and a therapy. Other embodiments include more or fewer categories.

In some embodiments, at least some medical findings have a properties table that includes sex, age, and over 80 other properties. A hierarchy of findings enables children (more detailed findings) findings to automatically inherit the properties of parent findings (higher levels in the hierarchy). Some of these control the display of findings in the note-style workspace. For example, testicular pain will not be displayed for a woman and menopause will not be displayed for a 6-year old.

The diagnosis table 192 includes a list of the available diagnoses, and maps each diagnosis to a unique diagnosis key. The diagnoses are then mapped to the findings using the findings importance table 194.

The findings importance table 194 associates each diagnosis of diagnosis table 192 with the relevant medical findings, and also identifies the relative importance of the medical finding to the diagnosis. The relative importance of each finding is assigned a number, such as a number in a range from 1 to 20. A low number means that that respective finding has relatively lower importance than a high number which has relatively higher importance to that finding. Other embodiments include other ranges of importance values.

The state table 196 associates findings with a state of that finding. In this example, the state table 196 identifies a finding with the finding key (from the medical finding table 190) and identifies an attribute of that finding. The finding and finding attribute are then associated with a state. In this example, the state is selected from a first state, such as positive, and a second state, such as negative. A negative state indicates that the finding and attribute are within a normal range, while a positive finding indicates that the finding and attribute are within an abnormal range. Other embodiments include other states, such as normal and abnormal. Yet other embodiments include more than two possible states. Attributes are sometimes alternatively referred to as values herein.

The color table 198 associates each available state with a color to identify the state in the caregiver interface. In this example, a negative state is associated with a first color (blue) and a positive state is associated with a second color (red). More or fewer states and colors are used in other embodiments. Further, other embodiments utilize formatting other than color, such as a style (regular, italics, bold, underline, double underline, etc.), or other visual indicators (graphical images or symbols, such as a red flag or plus sign as an identifier of an abnormal finding and a green circle or a minus sign as an indication of a normal finding, etc.).

The patient table 200 includes a list of one or more patients and maps each patient to a patient key. The patient data table 202 stores additional information about one or more patients. The patient data table 202 identifies the patient using the patient key from patient table 200, and further includes additional information about the patient. In one possible example, the additional information includes the patient's age, date of birth, and social security number. Other embodiments include more or less patient information.

The note data record table 204 includes a list of note data records. When a physician interacts with a patient, a summary of the caregiver's findings are stored in a note data record. The note data record table 204 includes a list of the note data records and maps each note data record to a note key. In this example, the note data record table 204 also maps the note data record to a patient using the patient key from the patient table 200 and includes the date that the record was generated.

The note details table 206 contains the summary of the findings for each note data record. In one example embodiment, the note details table 206 associates note data records with a category and a description or finding. For example, if a patient was complaining of having a cough, the note data record can be associated with a category of “symptom” and include a description or finding of “cough.” In some embodiments the descriptions are string data fields that store any data entered by the caregiver. In other embodiments the description is limited to specific findings selected from the medical finding table 190.

This example structure of the downloaded historical records 164 illustrated in FIG. 5 is an example of one possible structure. Various other embodiments utilize other data structures and contain more or less data fields as desired.

Although the downloaded historical records 164 are described as residing on the computing device 112, other possible embodiments store the historical records in other locations. For example, in some embodiments the historical records are stored on the server 104 or in the data center 108, rather than in the computing device 112. One such alternative embodiment provides the caregiver interface 118 through a computing device's Web browser software application, such as to provide the caregiver interface 118 as a service (e.g., Software as a Service). In this example, the server 104, or another server, performs many of the operations described herein instead of the computing device 112, such as illustrated and described in more detail with reference to FIGS. 6-7. Alternatively, in another possible embodiment the computing device 112 stores the downloaded historical records 164 in another database, such as on another computing device.

FIG. 6 illustrates another exemplary embodiment of an electronic medical records system 100. In this example, like the example illustrated in FIG. 1, the electronic medical records system 100 includes a healthcare information management system 102, a network 110, and client computing devices 112. Client computing devices 112 include stand-alone computing devices 112¹ and 112² as well as networked computing devices 112³ and 112⁴ that are connected to local area network 114. In this example, the client computing devices 112 include a Web browser 232. In addition, this embodiment further includes a Web server 230. In some embodiments the Web server 230 is part of the health information management system 102 (where server 230 can be part of server 104, or a separate computing device), while in other embodiments the Web server is separate from the health information management system 102. The health information management system 102 can communicate with Web server 230 across a local area network, or across the network 110, such as the Internet.

FIG. 7 is a schematic block diagram illustrating exemplary components of the electronic medical records system 100, including the Web server 230 and the computing device 112. In this example, the Web server 230 includes a user interface engine 242, a touch input evaluation engine 244, and a handwriting to text conversion engine 246. The computing device 112 includes Web browser 232. The Web browser includes a Web page rendering engine 252, as well as a touch input detection engine 254, and a touch input display engine 256, which are provided by the Web server 230 in some embodiments, through the touch interface script 250. The Web server 230 sends web page data 248 including the touch interface script 250 to the computing device 112, and receives touch input data 242 from the computing device 112.

A difference between the embodiment shown in FIG. 3 and the embodiment shown in FIG. 7 is that the handwriting recognition engine 178 resides on the computing device 112 in FIG. 3, while the handwriting recognition engine 243 is distributed across two or more computing devices 230 and 232 in FIG. 7. More specifically, the handwriting recognition engine 243 includes a server portion 243a (including touch input evaluation engine 244 and handwriting to text conversion engine 246) that operates on the server 230 and a browser portion 243b (including touch input detection engine 254 and touch input display engine 256) that operates within the browser 232 on the computing device 112.

The user interface engine 242 is the portion of the Web server 230 that generates and sends web page data 248. The web page data 248 is generated using predefined Web-page templates, for example, which are populated with data received from the health information management system 102. The web page data 248 is typically encoded according to one or more data protocols, such as hypertext markup language (HTML), which utilizes predefined tags to define how the web page data 248 will be rendered on the computing device 112.

The Web page data 248 is received by the computing device 112, which renders and displays the user interface defined by the web page data 248 using the web page rendering engine 252. The web page rendering engine 252 is the portion of the Web browser which interprets the encoding of the web page data to display the user interface on the touch sensitive display device 156 of computing device 112.

In some embodiments, the Web page data 248 also includes a touch interface script 250. The touch interface script 250 is, for example, code that can be executed by the computing device 112 utilizing the web browser 232. In this example, the touch interface script 250 includes code that is executed by the Web browser 232 run-time environment to generate the touch input detection engine 254 and the touch input display engine 256. An example of a suitable scripting language for the touch interface script 250 is JavaScript.

The touch input detection engine 254 detects touch inputs provided by the user through the touch sensitive display device 156. In an example embodiment, the touch input detection engine 254 identifies the points on the touch sensitive display 156 at which touch inputs are provided. The touch input detection engine 254 determines, for example, the coordinates of each point of the screen that is touched. A touch input, described herein, includes any input provided by an external object that is detectable by the touch sensitive display device 156, such as inputs provided by a finger, a glove, a stylus, or other input device. If a single tap is detected, a single point is recorded. In some embodiments, the single tap is interpreted as a click input and acted on in the same way as if a pointer click had been input at that location, such as to select one of the selectable controls from the user interface. If the touch input moves across the screen, all (or a subset) of the points of the screen that were contacted during the movement are recorded. The touch input data, which contains the coordinates for the point or points from the touch input, is then passed to the touch input display engine 256 and communicated to the touch input evaluation engine 244 of the Web server. In some embodiments, when a touch input is detected that moves across multiple points, the touch input detection engine continues to collect coordinates for the points of the touch input until the touch input is no longer detected (such as when the finger, stylus, or other object is removed from the screen). The collection of touch input points between an initial contact point and a final contact point is sometimes referred to herein as a stroke.

Some embodiments include a touch input display engine 256 that cooperates with the web page rendering engine 252 to graphically display strokes from a touch input, detected by the touch input detection engine 254, on the user interface. For example, if a stroke is detected in the shape of the number “2”, the color of pixels on the touch sensitive display device 156 corresponding to the points in the stroke is changed to a predetermined color, such as black, to make it appear as if the external object is actually leaving a trail of ink on the screen.

The touch input data 242 is also communicated to the Web server in some embodiments for further processing. In some embodiments, the touch input data 242 is communicated on a stroke-by-stroke basis, such that the touch input data 242 contains the data for a single stroke. In another possible embodiment, the touch input data 242 is not sent until a command is detected, and when a command is detected, any strokes that were entered prior to the command are collectively transmitted to the touch input evaluation engine 244. In yet another possible embodiment, the touch input data 242 is communicated point-by-point.

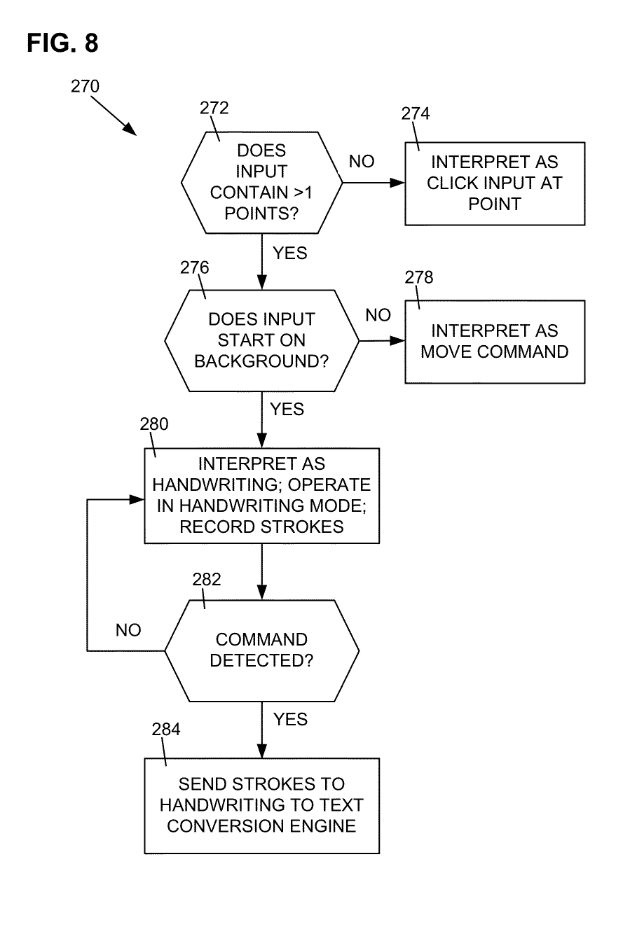

The touch input data 242 is sent to the Web server 230 across network 110 (FIG. 6), where it is received and processed by the touch input evaluation engine 244. The touch input evaluation engine 244 processes the touch inputs to determine whether the touch input is a click input, a move command, or a handwriting input. An example of the operation of the touch input evaluation engine 244 is illustrated and described in more detail with reference to FIG. 8.

When handwriting inputs are detected, the handwriting to text conversion engine 246 converts the handwriting inputs into a text form that can be more easily used by the computing devices 230 and 112. An example of a suitable handwriting to text conversion engine 246 is the handwriting recognition engine available with certain MICROSOFT® WINDOWS® operating systems, such as WINDOWS® 7 and WINDOWS® XP operating systems. If text is detected within the handwriting input, the text is returned to the user interface engine 242 where the data is stored within the patient note and updated within the web page data 248 for display in the user interface by the computing device 112.

FIG. 8 is a flow chart illustrating an example of the touch input evaluation engine 244 shown in FIG. 7. FIG. 8 also illustrates a method 270 of processing touch inputs detected by a computing device 112 (also shown in FIG. 7). In this example, method 270 includes operations 272, 274, 276, 278, 280, 282, and 284.

The operation 272 determines whether the touch input contains more than one point. If not, operation 274 interprets the touch input as a click input at the point, and the input is passed to the user interface engine 242 (shown in FIG. 7) for processing as a click input at that point. For example, the click input may operate to select a finding or heading in a patient note.

If the touch input has more than one point, the touch input is then evaluated in operation 276, which determines whether the input begins on a background of the user interface. To do so, operation 276 identifies the coordinates of the starting point of the touch input, and determines whether there are any objects, other than the background, that are present at the coordinates in the user interface. Objects can include a web page element, such as text, a table, a window, a selectable control (a button, radio button, check box, etc.), an image, or other objects displayed in the user interface. If the touch input is determined to begin on an object, operation 278 interprets the input as a move command. The move command is then passed to the user interface engine 242 where the command is executed, if appropriate.

A touch input that has a starting point on the background of the user interface is interpreted in operation 280 as a handwriting input, which initiates a handwriting mode. When operating in the handwriting mode, the touch input detection engine continues to record the strokes from the touch input detection engine 254. Other than the starting point, in some embodiments the handwriting input can be provided by the user over and across the objects in the user interface. This increases the writing space available in the user interface, so it is not limited to the white space (i.e., background space) and does not require a separate dedicated writing window in the user interface.

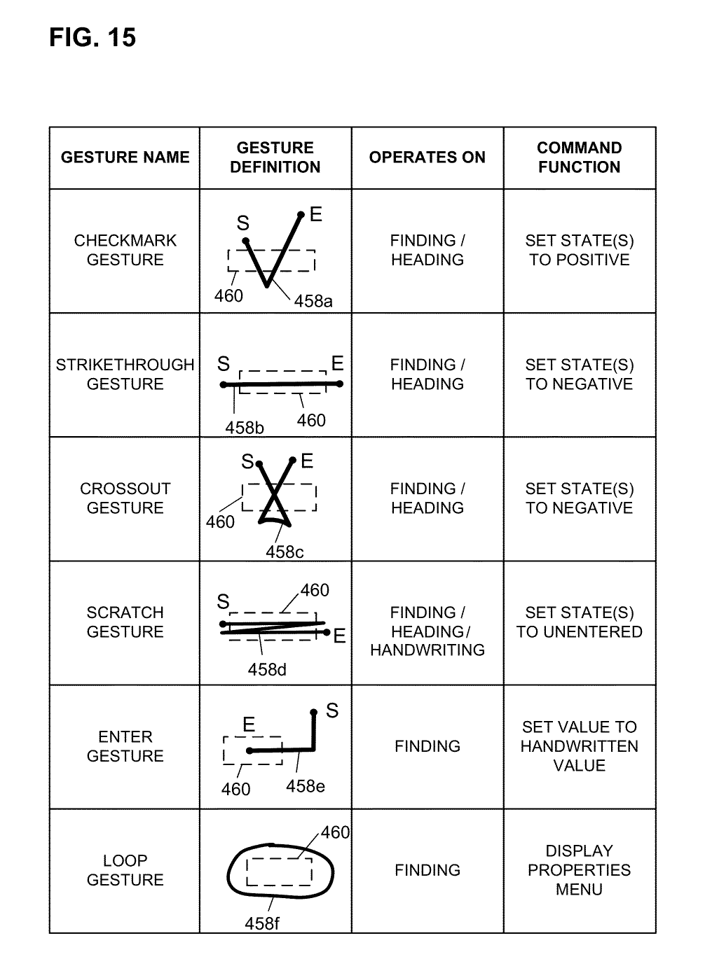

The handwriting mode continues until a command is detected in operation 282. Examples of handwritten commands are illustrated in FIG. 15. In some embodiments, each command is associated with a command definition. The command definition is provided for each command and describes the characteristics of a handwritten stroke that should be considered to be that command. Due to the fact that handwritten strokes are unlikely to have perfectly straight lines, perfectly curved arcs, or perfectly sharp corners, the command definitions permit some flexibility in the characteristics of the handwritten inputs that will be qualify as the command input. In addition, the handwriting inputs can also be processed to remove some of the variance from the input, such as by processing the handwritten input with one or more line smoothing, averaging, linear regression, or other similar functions prior to comparison of the handwritten input with the command definition.

When the command is detected, operation 284 sends the strokes of the touch input to the handwriting to text conversion engine 246 (FIG. 7), which converts the strokes of the touch input into individual text characters and provides the text to the user interface engine 242 for inclusion within the appropriate portion of the patient note. Examples of text characters are the American standard code for information exchange (ASCII) characters. Additional or different characters (such as characters used in other languages) are used in other embodiments. Operation 284 is not performed in some embodiments if the command detected in operation 282 does not require use of the touch input, such as when the command is a clear command, which is executed to clear the touch input from the computing device 112.

FIG. 9 is a screen shot of an example user interface 302 generated by the user interface engine 170 (shown in FIG. 3) or alternatively generated by the user interface engine 242 (shown in FIG. 7). The example user interface 302 includes a workspace 304. Some embodiments further include one or more of a toolbar 306, a content pane 308, a navigation bar 310, and historical note tabs 312.

In this example, the workspace 304 contains a patient note that is used by a caregiver to document a current encounter with a patient. In this example, the patient's name is William Atkins. A previously recorded patient note can alternatively be displayed in the workspace 304 to permit the caregiver to review findings from a previous encounter, such as by selecting one of the historical note tabs 312.

The exemplary patient note in workspace 304 includes note items (including headings/subheadings 320 and findings 360) and documentation regions 322. The headings 320 describe the topic of the documentation region 322 below the heading 320. For example, heading 322 indicates that the documentation region 342 is provided for documenting the patient's chief complaint. In this example, the documentation region 342 can be a text field in which the caregiver is permitted to enter free text describing the patient's chief complaint. Additional headings (and subheadings) 320 include history of present illness heading 324, past medical history subheading 326, personal history subheading 328, review of systems heading 330, systemic symptoms subheading 332, head symptoms subheading 334, neck symptoms subheading 336, ENT symptoms subheading 337, pulmonary symptoms subheading 338, and musculoskeletal symptoms subheading 339. Yet further headings are available by selecting the desired heading from the navigation bar 310, such as headings for examination, assessment, plan, tests, and therapy. Below or adjacent to each heading or subheading is the documentation region 340 for documenting findings associated with the heading topic, including regions 344, 346, 348, and 350 (where documentation region 350 includes multiple documentation regions). Additional documentation regions 340 are available for the other headings listed in the navigation bar 310, after selection of one of the headings from the navigation bar 310.

During a patient encounter, the caregiver documents the encounter by entering findings associated with the encounter. To assist the physician, common finding templates can be prepopulated in the patient note. The selection of templates is performed using the content pane 308.

In this example, the content pane includes a patient identification region 382, a sources region 384, and a favorites region 386. The patient identification region 382 include the name, and other biographical information about the patient, as desired, such as the patient's sex, date of birth, and current age.

The sources region 384 identifies the current templates that are being displayed in the workspace 304. In this example, the sources region 384 indicates that the upper respiratory template 390 is currently displayed in the workspace 304.

The favorites region 386 includes a list of the caregiver's most commonly used templates, so that they can be quickly and easily added to the patient note in the workspace 304, when needed. In this example, the caregiver has a gastroenterology template 392, multi-symptom template 394, and upper respiratory template 396. In addition, the physician also has a diagnosis of cholecystitis 398 included in the list of favorites, which can be selected to display findings within the workspace 304 that are commonly associated with this diagnosis. To add one of the favorites 386 to the sources region 384, the caregiver double clicks on one of the templates 392, 394, 396, or 398, or drags and drops the template into the sources region 384. In this example, the caregiver has added the upper respiratory template 396 into the sources region 384, which is displayed in the sources region 384 as upper respiratory template 390.

One a template has been added to the sources region 384, findings 360 from the template are added to the workspace 304, including findings 362, 364, 366, and 368, for example. Initially, the findings 360 are undocumented, and are therefore displayed in a grey color to indicate that they have not yet been documented for the patient encounter. If the caregiver determines that a finding is positive (abnormal), the caregiver can enter that finding by tapping once on the finding. For example, to indicate that the patient has symptoms of sinus pain, the sinus pain finding 362 is tapped once. Upon entry, the finding 362 is updated to a different colored font, such as red, to indicate that the finding was positive, as shown in FIG. 9. Alternatively, if the caregiver determines that the symptom of sinus pain is not present (negative, or normal), the caregiver can tap twice on the finding 362. The finding is then updated to another colored font, such as blue, to indicate that the finding was negative.

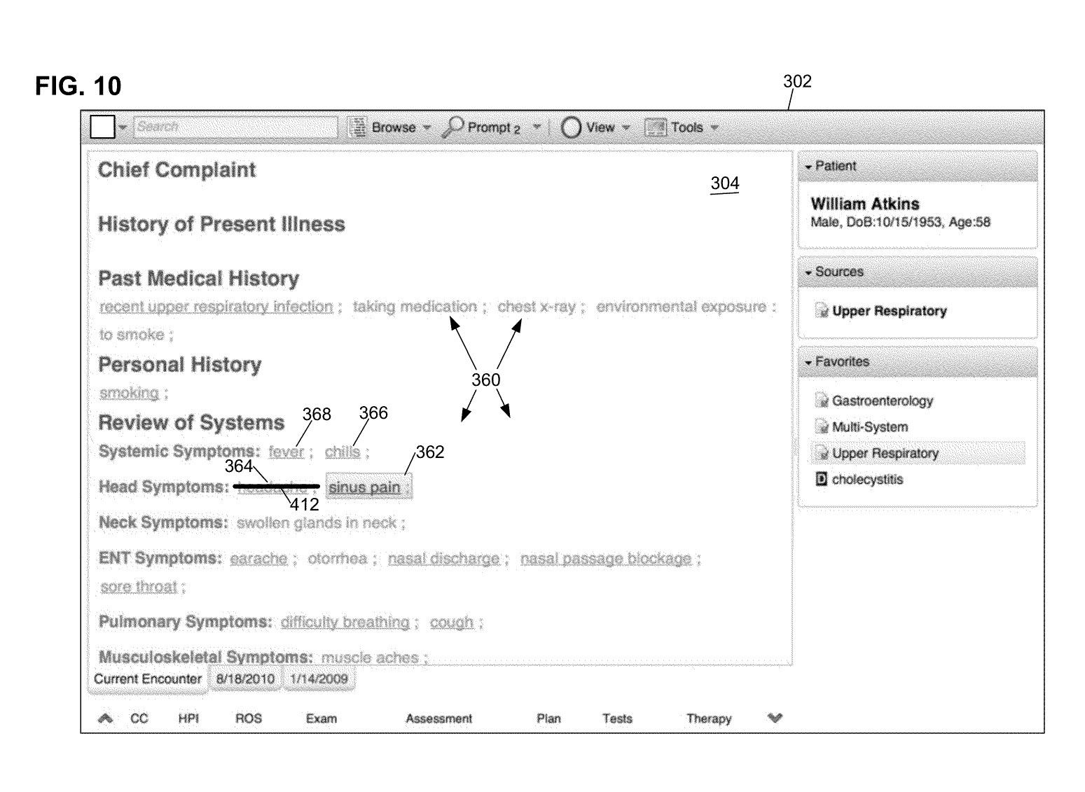

In another possible embodiment, however, documentation of the patient encounter can involve the use of gestures. Gestures are handwritten commands entered into the touch-sensitive display. Some examples of gestures are illustrated and described with reference to FIGS. 10-13 and 15.

When a finding, such as the sinus pain finding 362, has been entered or otherwise selected, the patient's medical record is searched to determine whether that finding exists in any prior patient note (e.g., within downloaded historical records 164, shown in FIG. 3). In this example, the sinus pain finding 362 was found in two prior notes, and so historical tabs 312 are displayed for each note, including historical tab 314 and historical tab 316. Within each tab, the date of the note is displayed with a font color indicating whether the finding was positive (e.g., red) or negative (e.g., blue). Selection of the note tab causes the user interface 302 to update to display the historical note for that date in the workspace 304. To return to the documentation of the current encounter, the caregiver selects the current encounter tab 318. Additional details are provided in U.S. Ser. No. 12/817,050, titled CAREGIVER INTERFACE FOR ELECTRONIC MEDICAL RECORDS, filed on Jun. 16, 2010, the disclosure of which is hereby incorporated by reference in its entirety.

FIG. 10 is a screen shot of the example user interface 302 illustrating an exemplary gesture input 412 provided to document a patient encounter. The user interface 302 is shown after the entry of the sinus pain finding 362, as described with reference to FIG. 9.

In this example, the caregiver wants to document the fact that the patient does not have a symptom of a headache. To do so, the caregiver provides a gesture input 412 over the headache finding 364. The gesture input 412 is a handwritten input provided into the touch-sensitive display that begins in front of the headache finding 364 and then moves generally horizontally through the headache finding 364, ending on or just after the headache finding 364. This gesture 412 can be referred to as a strikethrough gesture.

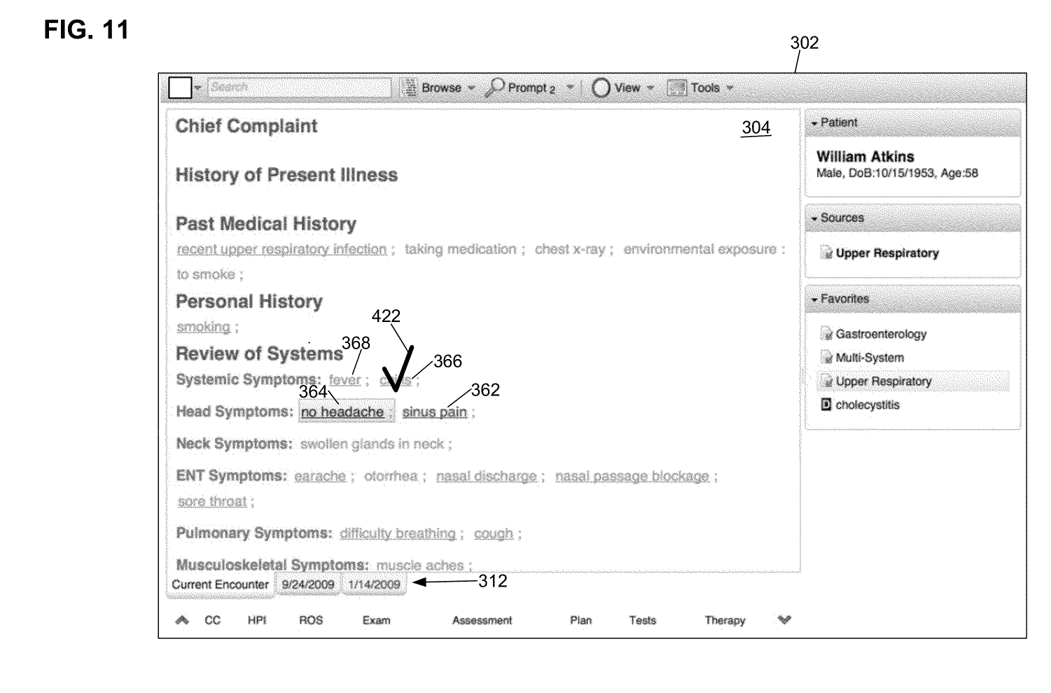

When the handwriting recognition engine 178 detects the strikethrough gesture, the handwriting recognition engine 178 determines that the caregiver has entered a command associated with a finding of negative (normal) for the finding 412. This command is then passed to the user interface engine 170/242, which enters the finding into the patient note (current record 176) and updates the user interface, such as illustrated in FIG. 11.

FIG. 11 is a screen shot of the example user interface 302 after receipt of the gesture input 412, described with reference to FIG. 10, and further illustrating the receipt of another gesture input 422.

Following the receipt of gesture input 412, the user interface 302 is updated to show that the finding 364 is negative (normal). In this example, the finding 364 is updated to display “no headache” with a font color representative of a negative finding (e.g., blue). The finding 364 remains selected, and accordingly the historical tabs 312 are updated to show the dates in which the finding 364 was previously documented in the patient's record.

FIG. 11 also illustrates another exemplary gesture input 422. In this example, the caregiver has determined that the patient has the symptom of chills, and therefore decides to document the chills as a positive finding in the patient note. To do so, the caregiver locates the chills finding 366, and provides the gesture input 422. The gesture input 422 begins at a point above the chills finding 366, moves diagonally down and to the right, crossing over the chills finding 366, stops below the chills finding 366, and then proceeds upward and to the right, crossing again over the chills finding 366, all in a single stroke. This gesture input 422 can be referred to as a checkmark gesture.

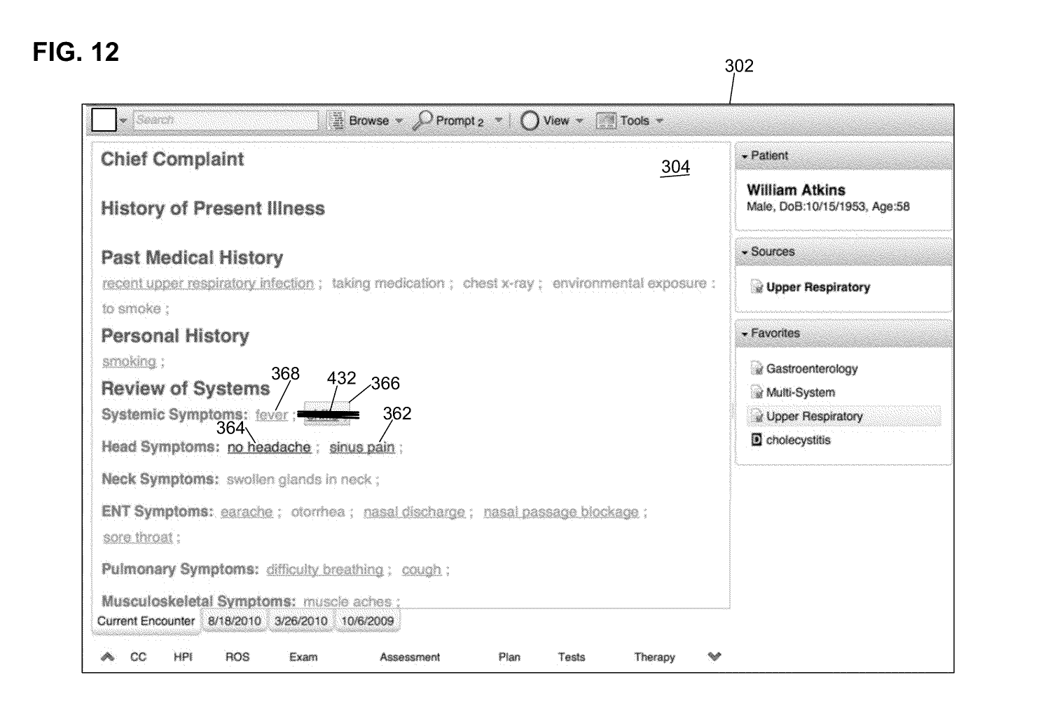

Once the stroke is completed, the handwriting input is evaluated as shown in FIG. 8. The handwriting input is determined to be a checkmark gesture, which is a command associated with a positive (abnormal) finding. Because the gesture was provided over the chills finding 366, the chills finding 366 is updated as positive in the patient note, and the user interface 302 displays the updated finding in the workspace 304, as shown in FIG. 12.

FIG. 12 is a screen shot of the example user interface 302 after receipt of the gesture input 422, described with reference to FIG. 11, and further illustrating the receipt of another gesture input 432.

Following the receipt of gesture input 422, the user interface 302 is updated to show that the chills finding 366 is positive (abnormal). For example, the font color of the chills finding 366 is changed to a color associated with a positive finding (e.g., red).

If the caregiver changes his or her mind after entering a finding, a gesture input 432 can be provided to clear a previously entered finding. In this example, after entering the chills finding 366, the caregiver determined that the chills finding 366 should not have been entered. For example, the caregiver may have intended to enter a different finding. One way for the caregiver to remove the finding is to tap on the finding 432 until the finding 432 is cleared. For example, the finding can be adjusted between positive, negative, and unentered with sequential taps.

Alternatively, a gesture input 432 is provided. In this example, the gesture input 432 involves a back-and-forth rubbing motion across the finding 366. The gesture input 432 includes, for example, a single stroke that begins to the left of the finding 366, proceeds generally horizontally to the right and across the finding 366, and stops to the right of the finding 366. The stroke then proceeds generally horizontally to the left and across the finding 366, and ends to the left of the finding 366. The stroke continues in this pattern as many times as desired by the user, such as 1.5 times, 2 times, 2.5 times, 3 times, etc. during which the input is moving back and forth across the finding 366. This gesture input 432 is referred to as a scratch gesture.

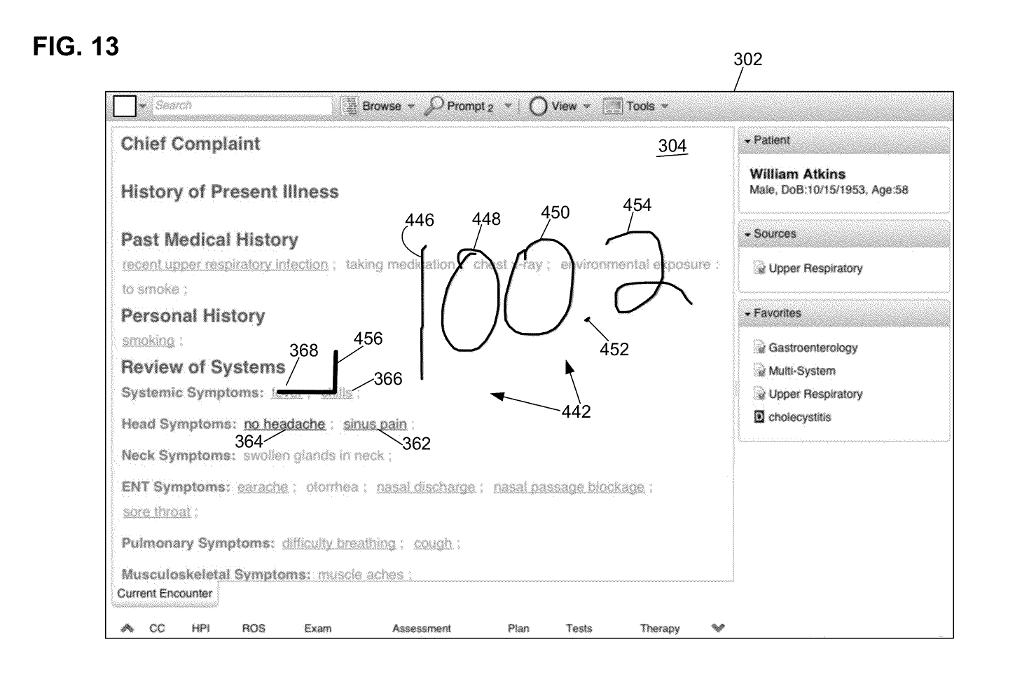

Once the stroke is completed, the handwriting input is evaluated as shown in FIG. 8. The handwriting input is determined to be a scratch gesture, which is associated with a clear command. Because the gesture input 432 was provided over the chills finding 366, the chills finding 366 is updated to the unentered state in the patient note and in the user interface 302, as illustrated in FIG. 13.

FIG. 13 is another screen shot of the example user interface 302 after receipt of the gesture input 432, described with reference to FIG. 12, and further illustrating the receipt of a handwriting input 442.

Following the receipt of gesture input 432, the user interface 302 is updated to clear the chills finding 366. As a result, the chills finding 366 is now displayed in a grey font indicating that the finding 366 is currently unentered.

Sometimes it is desirable for a caregiver to enter particular values associated with a finding 360. One way that such a value can be entered is by pulling up the finding properties menu. For example, by tapping and holding a finding, a properties window is displayed which includes a variety of possible fields, including a value field. The value field is selected by tapping, which displays a keyboard below the properties window. The keyboard can then be used to enter the value into the value field. When complete, the properties menu is then closed to complete the operation.

Another way to enter the value, however, is by providing a handwritten input into the workspace 304. For example, if the caregiver wants to enter the patient's temperature associated with a fever finding 368, the caregiver can provide the handwritten input 442.

In this example, the handwritten input 442 includes six total strokes, including five text-entry strokes 446, 448, 450, 452, and 454, and a gesture input 456. The handwritten input 442 is evaluated utilizing the process illustrated in FIG. 8, as it is entered. For example, the caregiver first provides stroke 446 representing the number 1. Referring to FIGS. 8 and 13, the stroke 446 is determined to contain more than one point (operation 272) and is determined to start on the background of the workspace 304. As a result, the handwritten input 442 is interpreted as handwriting, which initiates the handwriting mode. While in the handwriting mode, all subsequent strokes (448, 450, 452, 454, and 456) are considered handwriting inputs, regardless of whether they start on the background or on another object, such as one of the findings 360. As a result, the caregiver can proceed to write anywhere within the workspace 304, regardless of whether other objects are present at the location or not. This provides much more space for writing than if the handwriting input was limited to the background, or was limited to a dedicated handwriting input window within the user interface (which is therefore not required within the user interface 302). In this example, the caregiver provides the handwritten input over several findings, which are unaffected by the handwriting input.

After the first stroke 446 is completed, operation 282 evaluates the stroke to determine whether the stroke is in the shape of a command. It is not, and so the second stroke is processed in operations 280 and 282. The second stroke represents a zero, which is also determined to be an input other than a command. The strokes 450 (zero), 452 (period), and 454 (two) are similarly received and determined to be an input other than a command.

The stroke 456 is then received. Operation 280 records the stroke 456 and operation 282 evaluates the stroke 456 to determine if the stroke is a command. In this example, the stroke 456 is determined to be a gesture input associated with an enter command. The stroke 456 begins with a generally vertical downward stroke, followed by a left horizontal stroke that ends on finding 456. The stroke 456 has the general shape of a backwards “L” (or, alternatively, of an “L” that has been rotated ninety degrees counterclockwise). Accordingly, operation 284 sends the strokes (446, 448, 450, 452, and 454) that were received prior to the enter command of stroke 456 to the handwriting to text conversion engine 246 previously described herein with reference to FIG. 7.

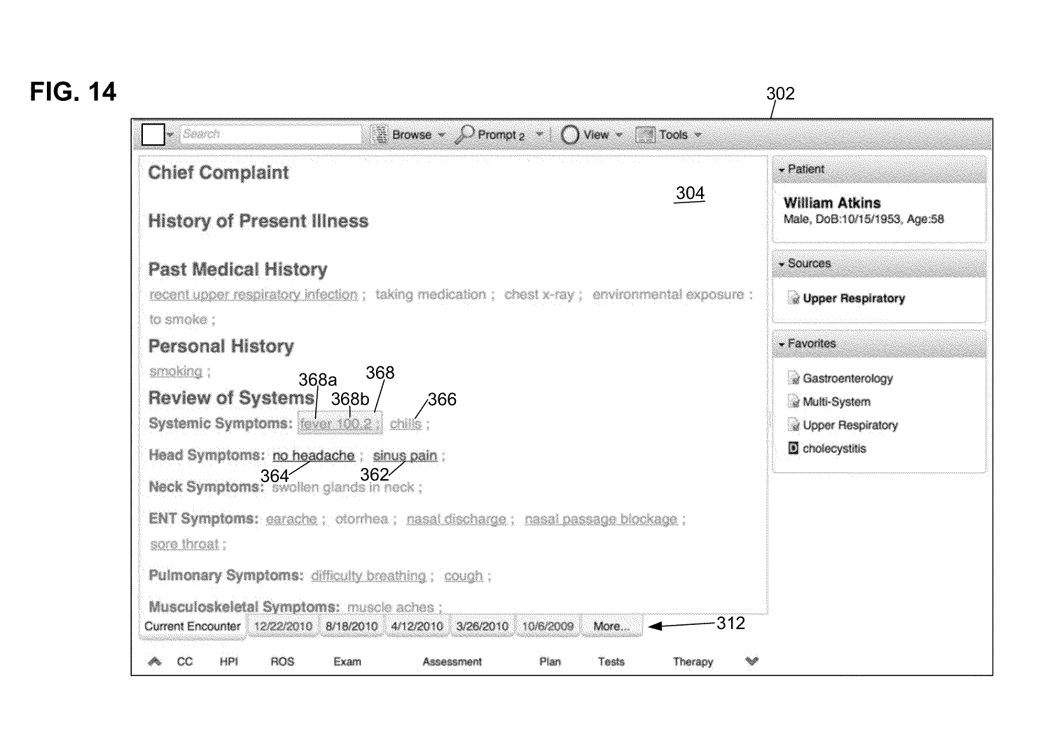

The handwriting to text conversion engine 246 converts the handwritten input 442 into a text input of “100.2” and enters this value into the fever finding 368 because the stroke 456 ended on the fever finding 368. The handwriting input 442 is also cleared from the workspace 304. The result is shown in FIG. 14.

FIG. 14 is another screen shot of the user interface 302 after receipt of the handwriting input 442, described with reference to FIG. 13.

After the handwriting input 442 has been converted to text, the text is linked to the fever finding 368, such as by storing the text as a value for the fever finding 368. In some embodiments, the text is also displayed with the finding 368. For example, the finding 368 is displayed with the finding identifier 368a (“fever”) and the value 368b (“100.2”). The handwriting is also removed from the workspace 304.

Once the finding 368 is updated, the finding 368 remains selected and historical tabs 312 are displayed that are linked to historical notes in which that finding (“fever”) has been previously entered in the patient's medical record.

In some embodiments, a table is included within workspace 304, and values are entered into the table by providing a handwritten input followed by a gesture input 456 (shown in FIG. 13) that ends within the cell of the table in which the value is to be inserted.

FIG. 15 is a table illustrating examples of gesture inputs 458. The table includes a gesture name, gesture definition, list of exemplary note items that the command operates on, and a description of what the command does when it is executed. Within the gesture definition column, “S” indicates the start of the gesture input 458, and “E” indicates the end of the gesture input 458. The rectangular box 460 drawn in phantom lines represents the note item (e.g., finding, heading, etc.) for which the command will be performed.

The table illustrates the checkmark gesture 458a, strikethrough gesture 458b, scratch gesture 458d, and enter gesture 458e that were previously described herein. For example, the operation of a checkmark gesture 458a is illustrated in FIG. 11, which operates to set the state of a finding to positive when the checkmark gesture 458a is made over that finding.

In addition, the table also indicates that at least some of the gestures 458 can be provided over a heading 320. Referring to FIGS. 9 and 15, if a gesture 458 is drawn over the review of systems heading 330, the function associated with the gesture 458 is performed across all (or a subset) of the findings 360 under that heading 330. For example, if the strikethrough gesture 458b is made over the review of systems heading 330, all unentered findings 350 under the review of systems heading 330 are entered as negative findings. As another example, if the scratch gesture 458d is made over the review of systems heading 330, all findings 350 under the review of systems heading 330 are set to unentered.

In some embodiments, multiple gestures are provided for a single command. For example, the strikethrough gesture 458b and the crossout gesture 458c can both be used to set a state of a finding to negative. In other embodiments, only one of the gestures 458b and 458c is permitted. A variety of other possible gestures 458 can be used in other embodiments, in addition to or instead of the exemplary gestures illustrated in FIG. 15.

In some embodiments the checkmark gesture 458a involves at least one stroke that extends diagonal (or angled) to the length of the note item 460. In some embodiments the strikethrough gesture 458b extends substantially parallel to the length of the note item 460. In some embodiments the crossout gesture 458c includes at least two stroke segments that intersect, where the stroke segments are part of the same stroke or are different strokes. In some embodiments the stroke segments are diagonal to a length of the note item 460. In some embodiments the scratch gesture 458d extends substantially parallel to a length of the note item 460, and crosses at least a portion of the note item 460 multiple times. Some embodiments require the scratch gesture 458d to include stroke segments extending in substantially opposite directions, and some embodiments require at least three stroke segments as shown in FIG. 15. In some embodiments the enter gesture 458e includes a stroke that ends on the finding 458e. In some embodiments the enter gesture 458e includes at least two stroke segments arranged at substantially right angles to each other. Some embodiments include a loop gesture 458f that includes a stroke having an arcuate or curved shape that at least partially surrounds at least a portion of a note item 460. Some gestures 458 begin on the background of the workspace and extend across at least a portion of a note item 460 to identify the note item 460 for which a command should be executed. In addition, other variations of the gestures shown in FIG. 15 can also be utilized.

One of the points illustrated by FIG. 15, is that the capability to receive gesture inputs 458 for a note item greatly increases the number of commands that can be performed directly through the touch-sensitive user interface for a given note item. Other types of inputs are much more limited. For example, commands that are executed upon receipt of a tap input are typically limited to one or two possible commands, because it becomes cumbersome to provide three, four, or more tap inputs to execute a command.

Furthermore, it is recognized that gesture inputs 458 are useful in a wide variety of applications, and are not limited to the exemplary use within a note-style interface described herein. The gesture inputs 458 can be similarly utilized to execute commands in a wide variety of other user interfaces where a touch-sensitive input device is used.

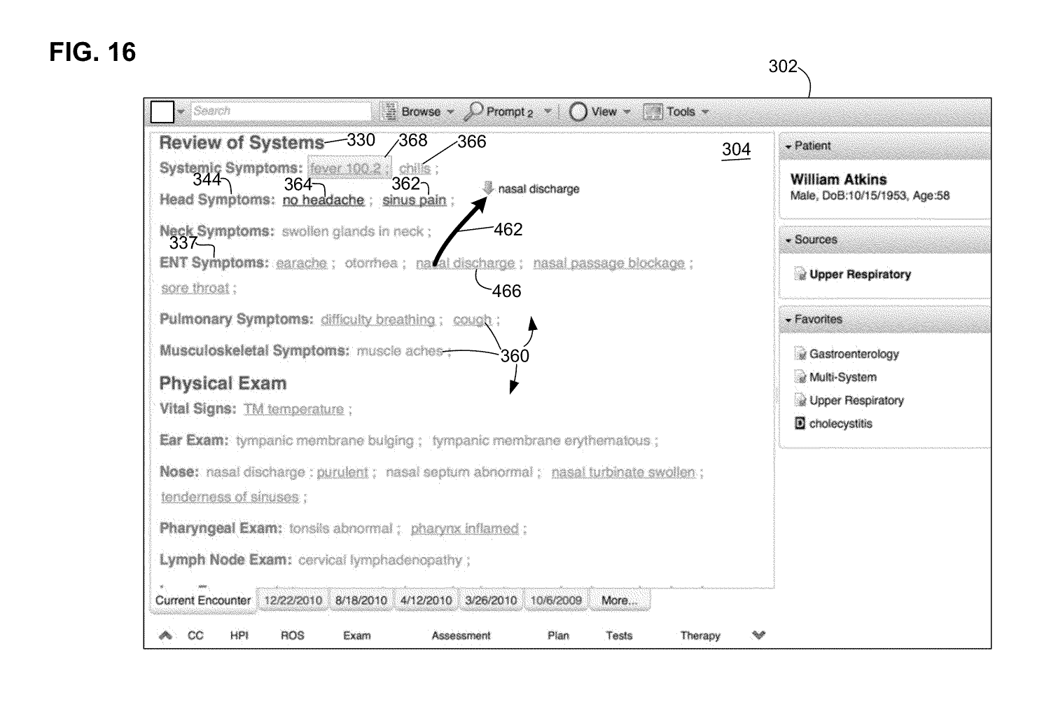

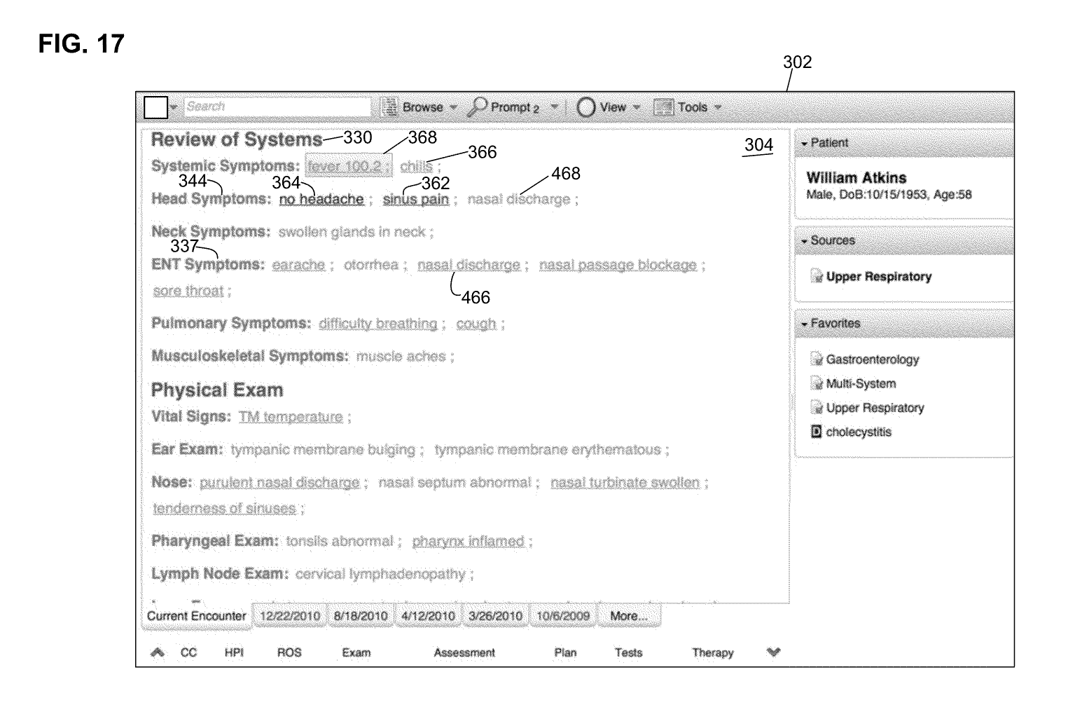

FIGS. 16-17 illustrate a move operation executed in response to a move input 462 provided through the touch-sensitive display device 156 (shown in FIG. 2). FIG. 16 is a screen shot of the user interface 302 illustrating the receipt of the move input 462.

In this example, the caregiver desires to move a finding from one portion of the patient note, to another portion of the patient note, in the workspace 304. More specifically, the caregiver wants to move the finding of nasal discharge from the documentation region following the ENT symptoms subheading 337, and into the documentation region following the head symptoms region 344.

This operation could be performed, in some embodiments, by selecting the documentation region following the ENT subheading 337, and then conducting a search, or browsing through a list of medical terms, to locate the appropriate finding and add it to the desired documentation region.

The touch-sensitive user interface 302, however, permits the caregiver to make the adjustment by entering a move input 462. The move input 462 begins at the location of the nasal discharge finding 466, moves along the workspace 304, and ends in the documentation region following the ENT symptoms subheading 337.

Referring to the flow chart in FIG. 8, the move input 462 contains more than one point, and is therefore evaluated in operation 276 to determine whether the move input 462 begins on the background. Since it does not, the input is interpreted as a move command in operation 278.

The move input 462 is therefore interpreted as a move command, and the move operation is performed to execute the command to move the finding 466 to the appropriate location within the patient note in the workspace 304. The result is shown in FIG. 17.

FIG. 17 is a screen shot of the user interface 302 following the move operation described in FIG. 16. In this example, the move operation caused the finding 466 from the documentation region following the ENT symptoms subheading 336 to be moved into the documentation region following the head symptoms 344 subheading.

In this example, the move operation does not delete the finding 466 from the original location, but rather generates a copy 468 of the finding 466 at the requested location. In another possible embodiment, however, the finding 466 is deleted once it is moved to the position of finding 468.

If desired, the finding 468 can then be entered into the patient note by tapping on the finding, or by providing a gesture input such as a strikethrough input or a checkmark input, as described herein.

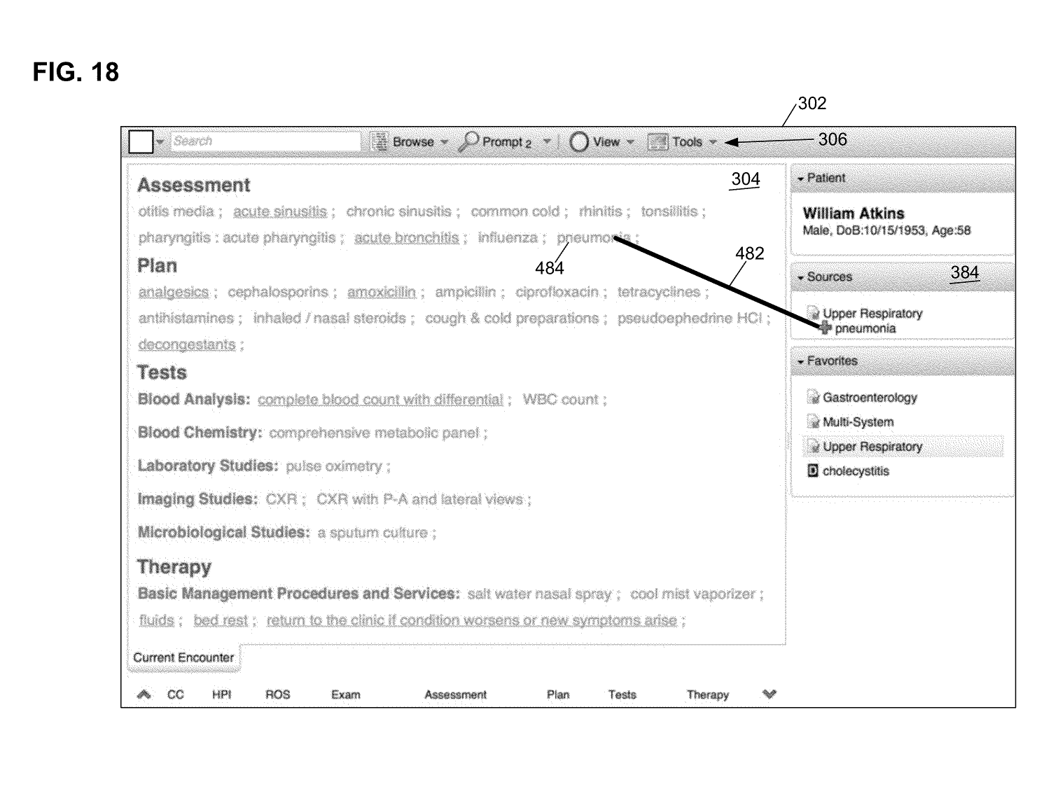

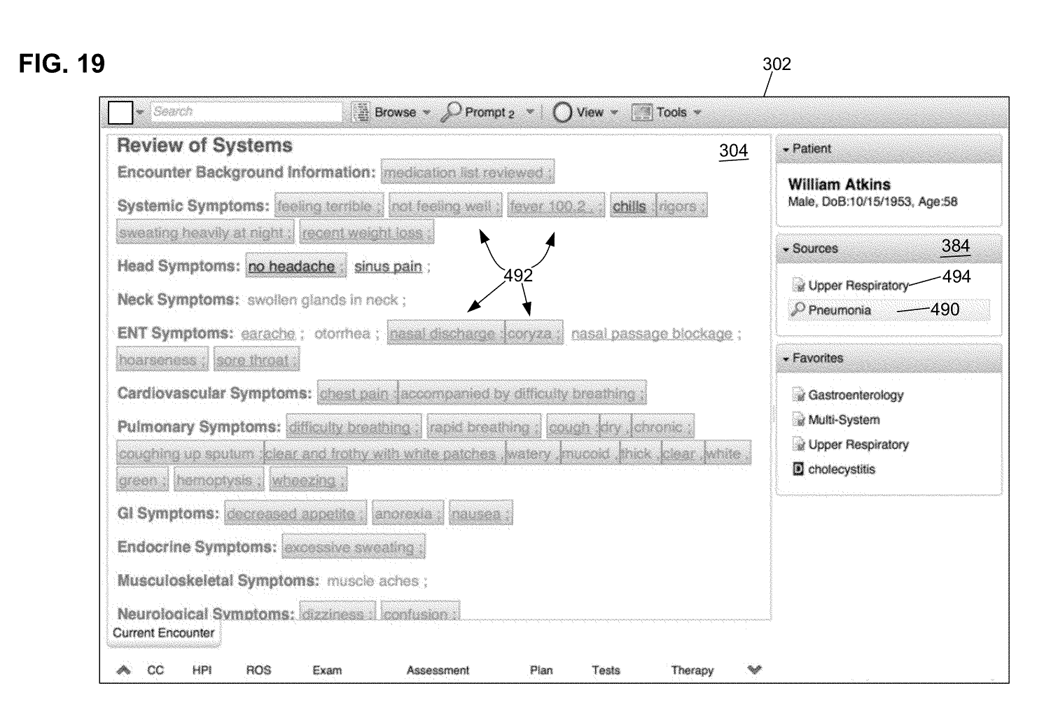

FIGS. 18-19 illustrate another example of a move operation executed in response to a move input 482 provided through the touch-sensitive display device 156 (shown in FIG. 2). FIGS. 18-19 also illustrate an example of an intelligent prompting operation performed in response to a move input 482.

FIG. 18 is a screen shot of the user interface 302 illustrating the receipt of the move input 482.

In this example, the caregiver wants to evaluate the current patient, William Atkins, to see if he might have pneumonia.

The operation could be performed, in some embodiments, by conducting a search using the search field in the toolbar 306, or by browsing through lists of terms using the browse option in the toolbar 306. Once the desired term is located, an option is selected to perform intelligent prompting utilizing the term, and upon selection of the intelligent prompting option, the term is added to the sources window 384.

The touch-sensitive user interface 302, however, permits the caregiver to perform this operation by providing a move input 482. The move input begins at the location of the pneumonia finding 484, moves along the workspace 304, and ends within the sources window 384.

Referring to the flow chart in FIG. 8, the input is interpreted as a move command in operation 278. Further, since the move input 482 ends in the sources window 384, rather than within the workspace 304, the move command is interpreted as a request to add the finding 484 to the sources window 384 in order to conduct an intelligent prompting operation on the finding 484. The result is shown in FIG. 19.

FIG. 19 is a screen shot of the example user interface 302 after a move operation to conduct an intelligent prompting operation on a selected finding, as discussed with reference to FIG. 18.

After receipt of the move input 482 (FIG. 18), the move command is executed to add the finding 484 to the sources window as source 490. In addition, a search is performed to identify all findings within the medical terminology that are diagnostically related to the finding of pneumonia. All such findings 492 are then added to the workspace 304 under the appropriate headings as unentered findings. Any findings 492 that are already in the user interface are not added to avoid duplication. The findings 492 are highlighted to help the caregiver differentiate between the findings that are associated with the selected source 490 (pneumonia) and those that are associated with another source 494 (e.g., upper respiratory). This permits the caregiver to review the findings that are related to pneumonia and enter those findings that are appropriate into the patient note. In doing so, the user interface assists the caregiver in evaluating the patient for pneumonia.

The process of automatically suggesting findings related to a selected finding can be referred to as intelligent prompting. Additional information about intelligent prompting is described in U.S. Pat. No. 5,823,949, titled Intelligent Prompting, issued on Oct. 20, 1998, the disclosure of which is hereby incorporated by reference in its entirety.

In some embodiments, a report generation engine is included to generate a report. The report can be generated to document the note in a formal document, including the findings that were entered into the patient note. Typically those findings that were displayed as a template but remained unentered are not included in the report. In some embodiments the report is displayed on the touch-sensitive display device. Alternatively, the report can be saved as a file, such as in a postscript data file (PDF) format. The report can be transmitted in an e-mail message, or as a file transfer across the network 110, for example.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

What is claimed is:

1. A method of documenting a patient encounter, the method comprising:
generating a note-style user interface containing a patient note with a computing device, the patient note including at least one note item describing an aspect of a patient encounter;
identifying a gesture input received through a touch-sensitive display, the gesture input identifying the note item; and
executing a command associated with the gesture input to perform an operation involving the note item.

2. The method of claim 1, wherein the operation modifies the note item in the note-style interface.

3. The method of claim 1, wherein the data defining the gesture input is generated based on detected points of contact between an external object and the touch-sensitive display, wherein the external object moves along the touch-sensitive display.

4. The method of claim 3, wherein the gesture input identifies the note item by crossing over the note item displayed on the touch-sensitive display.

5. The method of claim 4, wherein the gesture input begins on a background of the note-style interface and extends at least partially across the note item in a direction substantially parallel to a length of the note item.

6. The method of claim 5, wherein executing the command associated with the gesture input sets a state of the note item as negative in the patient note and displays the note item as a negative finding in the note-style interface.

7. The method of claim 5, wherein the note item is a heading, and wherein executing the command associated with the gesture input enters at least unentered note items associated with the heading as negative findings.

8. The method of claim 4, wherein the gesture input begins on a background of the note-style interface and proceeds at least partially across the note item in a direction substantially diagonal to a length of the note item.

9. The method of claim 8, wherein executing the command associated with the gesture input sets a state of the note item as positive in the patient note and displays the note item as a positive finding in the note-style interface.

10. The method of claim 9, wherein displaying the note item as a positive finding comprises changing a font color of the note item from a first color to a second different color.

11. The method of claim 1, wherein the note item is selected from the group consisting of: a heading of a patient note, a subheading of the patient note, and a clinical finding, wherein the clinical finding is selected from the group consisting of: a symptom, a medical history, a physical examination finding, a diagnosis, a test, and a therapy.

12. The method of claim 1, wherein generating a note-style user interface is performed by a server computing device that transmits the note style user interface as web page data for display through a browser software application operating on a mobile computing device, wherein the mobile computing device includes the touch-sensitive display.

13. The method of claim 1, further comprising:
identifying a handwriting input received by the touch-sensitive display into the note-style user interface;
identifying the gesture input as an enter gesture; and
wherein executing the command comprises converting the handwriting input into text and linking the text with the note item in the patient note.

14. The method of claim 13, wherein executing the command further comprises displaying the text with the note item in the note-style user interface.

15. The method of claim 13, wherein the handwriting input is provided within the patient note in the note-style user interface and crosses over multiple note items.

16. A method of documenting a patient encounter, the method comprising:
generating a note-style user interface containing a patient note with a computing device, the patient note including at least one note item describing an aspect of a patient encounter;
identifying an input received through a touch-sensitive display, the input including at least one stroke and identifying the note item; and
executing a command associated with the input to perform an operation involving the note item.

17. The method of claim 16, wherein the input is a move input that has a starting point on the note item.

18. The method of claim 17, wherein the move input has an ending point within the note-style user interface, and wherein executing a command associated with the input comprises inserting the note item in a region of the note-style user interface identified by the ending point of the input.

19. The method of claim 18, wherein the note-style user interface further comprises a list of active templates currently applied within the note-style interface, and wherein the endpoint identifies the list, and wherein inserting the note item in a region of the note-style interface comprises inserting the note item into the list of active templates.

20. The method of claim 19, further comprising:
identifying a set of findings that are diagnostically related to a diagnosis associated with the note item; and
adding at least some of the findings to the note-style interface as a template to assist a caregiver in evaluating the diagnosis.

21. An electronic medical records system comprising:
a server computing device including at least one processing device; and
at least one computer readable storage device in data communication with the server device, the at least one computer readable storage device storing data instructions, which when executed by the server computing device, cause the server computing device to generate:
a user interface engine that generates web page data defining a note-style interface including a patient note, the patient note including at least one note item, the note item defining a finding of a patient encounter; and
at least a part of a handwriting recognition engine that identifies a gesture input received through a touch-sensitive display of a mobile computing device, where the gesture input identifies the note item, and the handwriting recognition engine further executes a command associated with the gesture input to perform an operation involving the note item.

22. The electronic medical records system of claim 21, wherein the user interface engine further provides at least one script along with the web page data, the script including data instructions executable by the mobile computing device to generate a touch input detection engine, wherein the touch input detection engine detects handwriting input provided through the touch-sensitive display of the mobile computing device and transmits data defining the touch input data to the server computing device for processing by the handwriting recognition engine.
